(19) United States
(12) Patent Application Publication
(10) Pub. No.: US 2020/0238427 A1
(43) Pub. Date: Jul. 30, 2020

(54) WELDING DEVICE AND WELDING METHOD

(71) Applicant: HILTI AKTIENGESELLSCHAFT, Schaan (LI)

(72) Inventor: Uwe POPP, Widnau (CH)

(21) Appl. No.: 16/652,729

(22) PCT Filed: Oct. 5, 2018
(86) PCT No.: PCT/EP2018/077105

§ 371 Date: Apr. 1, 2020

(30) Foreign Application Priority Data
Oct. 10, 2017 (EP) 17195603.0

(51) Int. Cl. B23K 9/20

(52) U.S. Cl. CPC B23K 9/202; B23K 9/325; B23K 9/206

(57) ABSTRACT

A device for welding a welding stud to a substrate is provided, the device including a welding gun comprising a housing and a stud holder for the welding stud, a welding unit, a first electrical cable for conducting welding current from the welding unit to the welding gun, a second electrical cable for conducting the welding current from the substrate to the welding device, a gas container, and a gas line for conducting gas from the gas container to the stud holder, wherein the gas container is carried by the welding device.

### TECHNICAL FIELD

The invention relates generally to a device and to a method for fastening a stud to a substrate and also to such a stud.

### PRIOR ART

There are numerous known devices and methods by which various studs are fastened to a substrate in different applications. For example, a stud is brought into contact with the substrate and an electric current is applied to it. As soon as the electric current flows between the stud and the substrate, the stud is lifted off the substrate to form an arc. The energy that is released causes the material of the stud and the substrate to be partially liquefied. The electric current is then switched off and the stud is immersed in the liquefied material while this material cools down and becomes solid. The stud is then connected to the substrate in an integrally bonded manner.

In order to provide the necessary energy for liquefying the material of the stud and the substrate in a sufficiently short time, there are known devices that generate an electric current of a very high intensity and use a correspondingly rated electrical cable to feed it to the stud. To avoid oxidizing of the liquefied material, it is known to surround the area of contact between the stud and the substrate with an inert gas.

In the case of applications in building construction or shipbuilding for example, threaded studs of various sizes to which an item is screwed are used in order to fasten the item to the substrate. Some parameters of the fastening method, such as for example the duration and electrical power of the electric current, are to be set by a user on the device and are to be adapted to the stud that is used. The user finally assesses the quality of the connection between the stud and the substrate by means of a visual inspection. The quality of the connection consequently also depends on the experience and capabilities of the user.

### SUMMARY OF THE INVENTION

The object of the invention is to provide a device and/or a method with which fastening of a stud to a substrate is made easier and/or improved.

This object is achieved in the case of a device for welding a welding stud to a substrate, with a welding gun which comprises a stud holder for the welding stud, with a welding unit, with a gas container, with a gas line for conducting gas from the gas container to the stud holder, with a valve arranged in the gas line, and with a control device for controlling the valve, which is intended to open the valve for a predetermined period of time in order to flush the gas line with gas from the gas container. The automated flushing of the gas line will under some circumstances reduce the waiting time before a welding operation and/or the gas consumption.

An advantageous embodiment is characterized in that the control device is intended to initiate a welding operation when the predetermined period of time has elapsed. An alternative embodiment is characterized in that the control device is intended to signal to a user of the device that the device is ready for a welding operation when the predetermined period of time has elapsed.

A further advantageous embodiment is characterized in that the gas container is carried by the welding device, the gas line and/or the welding gun.

A further advantageous embodiment is characterized in that the device comprises a gas flow control device for controlling a gas flow through the gas line, the gas flow control device comprising the valve.

A further advantageous embodiment is characterized in that the device comprises a first electrical cable for conducting welding current from the welding device to the welding gun and a second electrical cable for conducting the welding current from the substrate to the welding device.

The object is likewise achieved in the case of a method for welding a welding stud to a substrate, in which a device is provided, with a welding gun, which comprises a stud holder for the welding stud, with a welding unit, with a gas container, with a gas line for conducting gas from the gas container to the stud holder, and with a valve arranged in the gas line, the valve being opened for a predetermined period of time in order to flush the gas line with gas from the gas container, and the welding stud being welded to the substrate while gas from the gas container is flowing around the welding stud.

An advantageous embodiment is characterized in that the welding of the welding stud to the substrate is initiated when the predetermined period of time has elapsed. An alternative embodiment is characterized in that a user of the device is signaled that the device is ready for a welding operation when the predetermined period of time has elapsed.

### EXEMPLARY EMBODIMENTS

The invention is explained in more detail below on the basis of exemplary embodiments with reference to the drawings, in which:

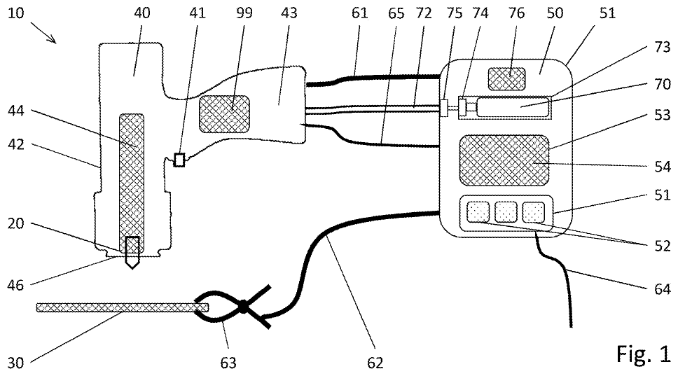

FIG. 1 schematically shows a welding device.

In FIG. 1, a welding device 10 for welding a welding stud 20 to a substrate 30 is schematically represented. A material of the welding stud 20 and a material of the substrate 30 are electrically conductive, in particular metallic. The welding device 10 comprises a welding gun 40 with a trigger switch 41 formed as a push-button switch, a welding unit 50 with a housing 51, a first electrical cable 61, a second electrical cable 62 with a connection terminal 63, an electrical supply cable 64, for example formed as a power cable, and an electrical communication line 65, a gas container 70 formed as a gas can or gas bottle and a gas line 72 formed as a gas hose.

The first cable 61 serves for supplying the welding stud 20 with electric current through the welding unit 50. The second cable 62 serves for electrically connecting the substrate 30 to the welding unit 50 when the connection terminal 63 is clamped to the substrate 30. When the welding stud 20 comes into contact with the substrate 30, a circuit closes, so that welding current, for example formed as DC current or AC current, can be applied to the welding stud 20 by the welding unit 50. For this purpose, the welding gun 40 comprises a welding-current contact element that is not shown in FIG. 1. The welding unit 50 comprises a device that is not shown for converting electric current from the supply cable 64 into welding current, which comprises for example an electrical capacitor, a thyristor, a bipolar transistor with an isolated gate electrode or other components from power electronics and also an associated control unit with a microprocessor, in order to provide the welding current at the desired voltage and current intensity.

The welding unit 50 has an input device 51 with actuating elements 52 and also an output device 53 with a visual display element 54 and a wireless transmission unit. The input device 51 serves for inputting parameters of a welding method to be carried out with the welding device 10, such as for example the electrical voltage, current intensity, power and time duration of the welding current, position and speed of the stud and so on, by a user of the welding device 10. The output device 53 serves for outputting information to the user, such as for example information on parameters of the welding method, information on detected emissions of the welding method or other variables, information on a quality of the welding operation, information on measures for improving the welding operation, information on detected characteristics of the welding stud or information derived from the aforementioned variables, and/or recommendations or instructions for cleaning and/or maintaining the welding device 10, in particular the welding gun 40.

The communication line 65 serves for communication between the welding gun 40, in particular a control device of the welding gun 40 that is not shown in FIG. 1, and the welding unit 50, in particular the control unit and/or the input device 51 and/or the output device 53. By means of this communication, for example, an exchange of information about the parameters of a welding operation is accomplished, in order for example to achieve or facilitate a synchronization of the welding current with a movement of the welding stud 20. In the case of exemplary embodiments that are not shown, the communication between the welding gun and the welding unit takes place wirelessly, by radio or by means of the first electrical cable, which carries the welding current.

The welding gun 40 has a housing 42 with an opening 46, from which housing a handle 43 with the trigger switch 41 protrudes. The welding gun 40 also has a stud holder 44, on which the welding stud 20 is held during a welding operation. For this purpose, the stud holder comprises for example two, three, four or more resilient arms that are not shown in detail, between which the welding stud 20 is inserted and held by means of a clamping fit. The welding gun 40 also has, for applying a welding current to the welding stud 20, a welding-current contact element which is integrated in the stud holder 44, for example in the form of one or more of the resilient arms.

The welding gun 40 also has a control device 99 for controlling the various components and devices of the welding gun and of the welding unit 50. The control device 99 is intended for controlling one or more parameters of the welding operation. For this purpose, the control device 99 comprises various electronic components, such as for example one or more microprocessors, one or more temporary or permanent data memories, and the like.

The welding gun 40 also has a stud lifting device, which is formed as a first lifting magnet, which acts on the stud holder 44 rearwardly (upwardly in FIG. 1) with a force away from the opening 46 when the stud lifting device is activated. Via a signal line that is not shown, the control device 99 communicates with the stud lifting device in order to control the stud lifting device, in particular to activate and deactivate it.

The welding gun 40 also has a stud immersing device, formed as a spring element or as a second lifting magnet, which acts on the stud holder 44 forwardly (downwardly in FIG. 1) with a force toward the opening 46 when the stud immersing device is activated. Via a signal line that is not shown, the control device 99 communicates with the stud immersing device in order to control the stud immersing device, in particular to activate and deactivate it. If the stud immersing device is formed as a spring element, this spring element is preferably tensioned when the stud holder is moved rearward by the stud lifting device, with the result that the spring element moves the stud holder forward as soon as the stud lifting device is deactivated.

The gas line 72 serves for supplying a contact region between the welding stud 20 and the substrate 30 with an inert gas from the gas container 70, in order to protect the contact region from oxidation due to oxygen from a surrounding area during a welding operation. The gas line 72 conducts the inert gas to the stud holder 44.

The welding device 50 has a gas container receptacle 73, which is arranged in the housing 51 and in which the gas container 70 is exchangeably received, so that the gas container 70 is carried by the welding unit 50. In the case of an embodiment that is not shown, the gas container is attached, in particular fastened, to the outside of the welding unit, for example on its housing. The gas line 72 has a gas connection element 74, which is arranged on the gas container receptacle 73 for connecting the gas container 70 to the gas line 72. Furthermore, the welding device 10, and in particular the welding unit 50, has a gas flow control device 75 formed as a valve, in particular a solenoid valve, for controlling a gas flow through the gas line 72, the gas flow being controlled for example by a cross-sectional area of the gas flow control device 75 being set or by a time duration or frequency of one or more open phases of the gas flow control device 75 being set. The control of the gas flow is preferably matched to the other parameters of the welding operation and/or the gas volume in the gas line 72.

The gas flow control device 75 is arranged completely in the housing 51 and carried by the welding unit 50 and serves for controlling a gas flow to the contact region between the welding stud 20 and the substrate 30. The gas flow control device 75 comprises a controllable valve, which is for example controlled by the control device 99. Among other things, the control device 99 is intended to open the valve for a predetermined period of time in order to flush the gas line 72 with gas from the gas container, and to initiate a welding operation or to signal to a user of the welding device 10 the readiness of the welding device 10 for a welding operation when the predetermined period of time has elapsed. The automated flushing of the gas line 72 under some circumstances reduces the waiting time before a welding operation and/or the gas consumption.

Furthermore, the welding device 10, and in particular the welding unit 50, has a filling level detection device 76 for the gas container 70. The filling level detection device 76 is preferably arranged completely in the housing 51 and carried by the welding unit 50. The filling level detection device 76 comprises a pressure sensor arranged in the gas line 72, for example on the gas connection element 74, for measuring the internal pressure of the gas container, and a data processing device, which detects the number of welds that have taken place. In the case of exemplary embodiments that are not shown, the filling level detection device comprises a sensor, in particular for measuring the weight or the inertia of the gas container, the pressure or temperature gradient during control of the gas flow, an acoustic response of the gas container content or the like. Additionally or alternatively, the filling level detection device 76 comprises a storage medium, which is attached to the gas container 70, and a data processing device, which is carried by the welding unit and is suitable for storing information about a filling level of the gas container 70 on the storage medium and/or for reading such information from the memory and/or for outputting it by means of the output device 53, for example its display element 54.

In the case of a welding method with the welding device 10, first the substrate 30 and the stud 20 are provided. In a further step, information, for example about desired parameters of the following welding operation, are input by a user via the input device. In a further step, a welding current between the welding stud 20 and the substrate 30 is applied to the welding stud 20 by the welding unit 50 by means of the first cable 61 and the second cable 62. In a further step, the welding stud 20 is lifted off the substrate by means of the stud lifting device while maintaining the welding current flowing between the welding stud 20 and the substrate 30, with an arc being formed between the welding stud 20 and the substrate 30. Particularly on account of the heat generated by the arc, a material of the welding stud 20 and/or of the substrate 30 is then partially liquefied. In a further step, the welding stud 20 is immersed by means of the stud immersing device in the liquefied material of the welding stud 20 or of the substrate 30. The liquefied material of the welding stud 20 or of the substrate 30 then solidifies such that the welding stud 20 is connected to the substrate 30 in an integrally bonded manner.

In order to flush the gas line 72 with gas from the gas container 70, the valve of the gas flow control device 75 is opened for a predetermined period of time, and the welding stud 20 is welded to the substrate 30 while gas from the gas container 70 is flowing around the welding stud 20. The welding of the welding stud 20 to the substrate 30 is initiated when the predetermined period of time has elapsed. Alternatively, a user of the welding device 10 is signaled that the device is ready for a welding operation when the predetermined period of time has elapsed. This automatic flushing of the gas line is preferably always carried out, in particular only carried out, when the welding device 10 is switched on and/or after a long standstill and/or after parts of the gas line 72 have been exchanged.

The individual method steps are controlled by the control device 99, which in particular also controls the parameters of the welding method, such as for example an electrical voltage, a current intensity and a duration of the welding current, or a point in time and a speed of the stud movement, or a stud position, or a gas flow through the gas line 72. Furthermore, a filling level of the gas container 70 and the number of welds that have been carried out are detected, stored and output.

The invention has been described on the basis of examples of a device for fastening a first item to a second item and a production method for such a device. The features of the embodiments described can also be combined as desired with one another within a single fastening device or a single production method. It is pointed out that the device according to the invention and the method according to the invention are also suitable for other purposes.

1. A device for welding a welding stud to a substrate, comprising a welding gun, which comprises a stud holder for the welding stud; a welding unit: a gas container; a gas line for conducting gas from the gas container to the stud holder; a valve arranged in the gas line; and a control device for controlling the valve, wherein the control device is arranged to open the valve for a predetermined period of time to flush the gas line with gas from the gas container.

2. The device as claimed in claim 1, wherein the control device is arranged to initiate a welding operation when the predetermined period of time has elapsed.

3. The device as claimed in claim 1, wherein the control device is arranged to signal to a user of the device that the device is ready for a welding operation when the predetermined period of time has elapsed.

4. The device as claimed in claim 1, wherein the gas container is carried by the welding unit, the gas line and/or the welding gun.

5. The device as claimed in claim 1, further comprising a gas flow control device for controlling a gas flow through the gas line, the gas flow control device comprising the valve.

6. The device as claimed in claim 1, further comprising a first electrical cable for conducting welding current from the welding unit to the welding gun and a second electrical cable for conducting the welding current from the substrate to the welding unit.

7. A method for welding a welding stud to a substrate, comprising
a) providing a device comprising a welding gun, which comprises a stud holder for the welding stud; a welding unit; a gas container; a gas line for conducting gas from the gas container to the stud holder; and with a valve arranged in the gas line,
b) opening the valve for a predetermined period of time to flush the gas line with gas from the gas container, and
c) welding the welding stud to the substrate while gas from the gas container is flowing around the welding stud.

8. The method as claimed in claim 7, in which c) is initiated when the predetermined period of time has elapsed.

9. The method as claimed in claim 7, including signaling a user of the device that the device is ready for a welding operation when the predetermined period of time has elapsed.

10. The device as claimed in claim 2, wherein the gas container is carried by the welding unit, the gas line and/or the welding gun.

11. The device as claimed in claim 3, wherein the gas container is carried by the welding unit, the gas line and/or the welding gun.

12. The device as claimed in claim 2, further comprising a gas flow control device for controlling a gas flow through the gas line, the gas flow control device comprising the valve.

13. The device as claimed in claim 3, further comprising a gas flow control device for controlling a gas flow through the gas line, the gas flow control device comprising the valve.

14. The device as claimed in claim 4, further comprising a gas flow control device for controlling a gas flow through the gas line, the gas flow control device comprising the valve.

15. The device as claimed in claim 2, further comprising a first electrical cable for conducting welding current from the welding unit to the welding gun and a second electrical cable for conducting the welding current from the substrate to the welding unit.

16. The device as claimed in claim 3, further comprising a first electrical cable for conducting welding current from the welding unit to the welding gun and a second electrical cable for conducting the welding current from the substrate to the welding unit.

17. The device as claimed in claim 4, further comprising a first electrical cable for conducting welding current from the welding unit to the welding gun and a second electrical cable for conducting the welding current from the substrate to the welding unit.

18. The device as claimed in claim 5, further comprising a first electrical cable for conducting welding current from the welding unit to the welding gun and a second electrical cable for conducting the welding current from the substrate to the welding unit.

19. The device as claimed claim 10, further comprising a gas flow control device for controlling a gas flow through the gas line, the gas flow control device comprising the valve.

20. The device as claimed claim 11, further comprising a gas flow control device for controlling a gas flow through the gas line, the gas flow control device comprising the valve.
